(19) United States
(12) Patent Application Publication
(10) Pub. No.: US 2007/0022133 A1
(43) Pub. Date: Jan. 25, 2007

(54) Method and apparatus for automatically and configurably adjusting allocated database resources to avoid denial of service

(75) Inventor: Soloman J. Barghouthi, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/186,600

(22) Filed: Jul. 21, 2005

(51) Int. Cl. G06F 7/00

(52) U.S. Cl. 707/102

(57) ABSTRACT

A client or client representative of a database maintains a configurable table of database messages and associated values, at least some of which include references to commands to be executed upon the occurrence of the message being issued from the database. One or more of these command sets respond to a lack of resource message by causing the system to automatically increase the allocated resources of the database to allow the request to be processed, preferably transparently to the client. After increasing the resource allocation, the request is then automatically retried.

### FIELD OF THE INVENTION

The present invention relates generally to digital data processing, and more particularly to the allocation of resources of a database to multiple client users in a digital computing system.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system typically comprises hardware in the form of one or more central processing units (CPU) for processing instructions, memory for storing instructions and other data, and other supporting hardware necessary to transfer information, communicate with the external world, and so forth. From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Programs which direct a computer to perform massive numbers of these simple operations give the illusion that the computer is doing something sophisticated. What is perceived by the user as a new or improved capability of a computer system is made possible by performing essentially the same set of very simple operations, but doing it much faster.

Complex systems may be used to support a variety of applications, but one common use is the support of large databases, from which information may be obtained. Conceptually, a database may be viewed as one or more tables of information, each table having a large number of entries or records (analogous to rows of a table) of a common format, each entry having multiple respective data fields (analogous to columns of the table). Database management software provides the ability to define the parameters of the database, to create new database records, edit existing records, and so forth. In particular, large databases usually support some form of database query for obtaining information which is extracted from selected database fields and records. Operations performed by database management software, and particularly database queries, can consume significant system resources.

A large database is often intended to provide information to a variety of users. Many computer systems containing large databases provide database access according to a client-server model, in which the user of the database (the client) requests some service of the database (such as the execution of a query against information in the database), and the database management software functions as a server to perform the requested service using the database information and return results (e.g., requested information, acknowledgment that an operation was performed, etc.) to the client. Use of a client-server model facilitates access to database information where the clients are located at different computer systems, often physically remote from the database system.

Client-server interaction with one or more databases can be very complex. The scope and type of information stored may vary. Databases have a particular structure, including one or more tables, structure of entries within each table, auxiliary database structures such as indexes, histograms, etc. for assisting queries, and so forth. It is desirable to shield users and or user applications from these details of database design. A family of middleware applications, herein called a “middle tier facility” or “middle tier”, is often interposed between the clients and the database can provide a convenient means for accessing one or more databases. To the client, the middle tier appears as the server. I.e., the client's direct interaction is with the middle tier, which services its requests. The middle tier may contain any of various complex applications user for servicing client requests. Servicing at least some requests requires access to data in a database, although in many cases there will be other requests can be serviced entirely within the middle tier, without accessing a database. To the database, the middle tier is an intermediate application which represents multiple clients in their transactions with the database. The middle tier may support access to multiple databases, and some requests may require that data be obtained from multiple databases to satisfy the request. Data obtained from a database might be returned directly to the client, or might be processed by the middle tier to generate other data, which may be returned to the client and/or re-stored in the database. A form of client-server environment in which a client accesses a database through such middleware is sometimes referred to as a three-tier environment.

In any complex system, it may be necessary to allocate resources to certain users, processes, or components to achieve optimal operating efficiency, balancing of access rights, and for other considerations. A database may allocate internal resources to users, groups or users or applications accessing the database. For example, a database may allocate a particular number of simultaneous client accesses, a size of logs of access activities, a size of memory structures for executing queries and holding temporary query results, and so forth. These allocations may be used to assure that the allocated resources are available, but they can also function as limits on the resources available to perform requested services.

Many databases operate to provide critical services to their users, and it is desirable that these databases always be available to provide services whenever users request them. Resource allocations may limit the services available, i.e., may in some circumstances cause a database to deny service to a requesting client. Because denial of service can cause severe problems for the clients, when allocating database internal resources, there is a tendency to over-allocate in order to assure that service will not be interrupted. Over-allocation of resources to the database can have collateral consequences. Other processes executing on the system may be starved for resources, while the database reserves resources which are often not used. Alternatively, the operator of the database may provide significantly more computing resources than necessary (at significant additional cost), to avoid interruption of database service.

If, on the other hand, resources allocated are even sporadically insufficient, the users of the database will perceive frequent outages and denial of service, which is generally unacceptable.

Where there is a denial of service, one response is for a database administrator or other person to increase the resource allocation so that the requested service can be provided. This is not a wholly satisfactory solution, because it relies on manual intervention of the database administrator, thus consuming additional human resources, and because the administrator may not be able to respond sufficiently quickly to prevent at least some denial of service.

This problem has been recognized, and in the case of at least one commonly used database management facility known as “DB2”, the database management facility has the capability to automatically increase resource allocation where the system would otherwise deny service. Automatically increasing the resource allocation will permit the database to provide the requested service, although there may be a greater time delay than would have been the case had the necessarily resources been allocated in the first place.

A built-in function of the database management facility which automatically increases allocated resources in response to a request for which there are insufficient resources is clearly useful, but it has its limitations. For one thing, it is not universally available: there remain other database management facilities, or even older versions of the same facility, which do not provide this function. Secondly, the function may lack flexibility to address the problem. It may be desirable, for example, to automatically increase allocated resources only in certain defined circumstances, or only on behalf of certain users.

A need therefore exists for improved techniques for managing database resources which both avoid excessive resource allocation and effectively deal with the problem of denial of service to users.

### SUMMARY OF THE INVENTION

A client application or client representative maintains a configurable table of database messages and associated values for interactions with a database. The associated values can include, among other things, references to command sets to be executed upon the occurrence of the message being issued from the database. One or more of these command sets respond to a lack of resource error message by causing the system to automatically execute commands increasing the allocated resources of the database to allow the request to be processed. After increasing the resource allocation, the request is then automatically retried.

In the preferred embodiment, the mechanism for automatically increasing resource allocation in appropriate circumstances is embodied in an application server of a middle tier facility which represents multiple clients to the database. The application server is a framework or shell for supporting database accesses on behalf of one or more applications of the middle tier. An application within the middle tier invokes the connection facilities of the application server to obtain database access. The application server receives responses from the database, including messages, and takes appropriate action responsive to messages according to its message table.

A reference to a command set in the table of database messages may take any of various forms, including commands in a command line file or commands directly in the table, which could be combined in any single embodiment. These commands are preferably commands according to a database command line interface. Commands of a command line interface are not directly executable commands, but are commands which are interpreted by a command line execution facility within the database. Upon receipt of an error message from the database, the table of database messages is referenced, and the corresponding commands are executed. The command line interface preferably supports conditional logic and branching, so that the command line file may cause behavior of arbitrary complexity. In particular, a set of commands responsive to an error message indicating lack of resource may not only increase the resource allocation, but may increase the resource allocation dependent on the satisfaction of some logical condition of arbitrary complexity, or may increase the resource allocation by a variable amount, the variable amount being dependent on some logical condition of arbitrary complexity.

In the preferred embodiment, the increase of resource allocation is performed entirely within the application server, transparently to the client. The client never sees the original error message from the database indicating lack of resource. From the client's perspective, the only effect of a lack of resource is that it may take slightly longer to service the request than would have been the case had sufficient resource been allocated originally.

By intercepting error messages and automatically executing commands sets referenced by a table in accordance with the preferred embodiment of the present invention, service denials can be reduced or eliminated notwithstanding that the original allocation of resources was insufficient, and therefore it is no longer necessary to over-allocate database resources to avoid denial of service. Furthermore, a system for automatically adjusting resources as described herein is not dependent on any capability of the database itself to automatically adjust resources (and therefore is effective with databases which do not have such capability), is more readily configurable to provide a flexible response to lack of resource exceptions which can vary with different clients, different system resource utilization state, or other environmental circumstances.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level representation of a typical three-tier environment for accessing information in a database, according to the preferred embodiment of the present invention.

FIG. 2 is a high-level block diagram of the major hardware components of a server computer system for performing services relating to database access on behalf of clients, according to the preferred embodiment.

FIG. 3 is a conceptual illustration of the major software components of a computer system for maintaining a database, according to the preferred embodiment.

FIG. 4 is a conceptual illustration of the major software components of a computer system operating a middle tier facility, according to the preferred embodiment.

FIG. 5 is a conceptual representation of the structure of a message translation table and entities it references, according to the preferred embodiment.

FIG. 6 is a flow diagram illustrating at a high level the process of servicing a client request for database access through the middle tier, according to the preferred embodiment.

FIG. 7 shows in greater detail the process of generating and handling a message from the database, according to the preferred embodiment.

### DETAILED DESCRIPTION OF THE PREFERRED EMBODIMENTS

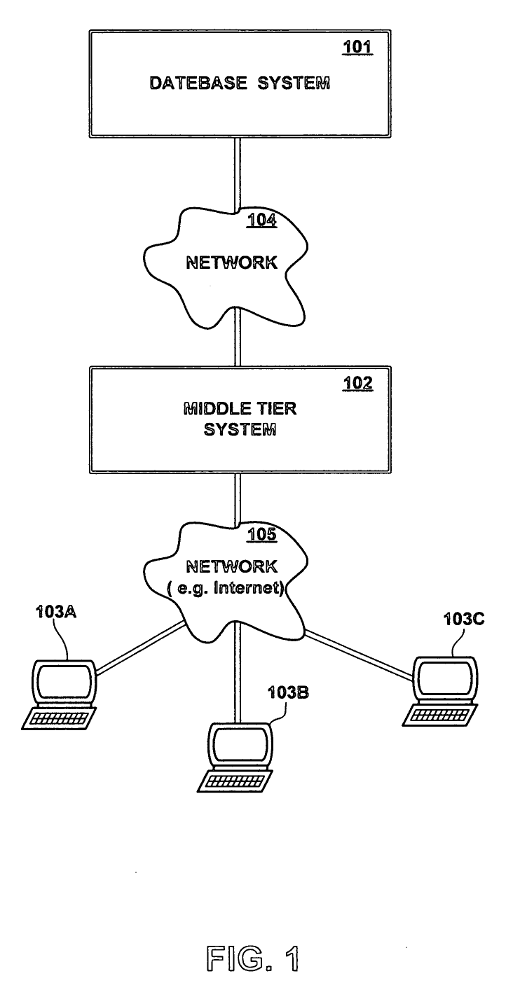

Referring to the Drawing, wherein like numbers denote like parts throughout the several views, FIG. 1 is a high-level representation of a typical three-tier environment for accessing information in a database, according to the preferred embodiment of the present invention. Database system 101 is a computer system containing one or more databases of information, and which functions as a server to respond to requests from clients for access to the information in the database(s). Clients 103A-C (herein generically referred to as feature 103) generate requests for service to middle tier system 102, at least some of these requests requiring access to information in the database(s) of database system 101. Middle tier system 102 acts as a server to clients 103; it may provide various services to the clients (not all of which necessarily involve database access), but in particular it functions as an intermediary between the clients 103 and the database system 101 in handling client requests to access information in the database. Where necessary to provide a requested service, middle tier system uses the client request for information in a general form to generate one or more requests to database system 101 in a specific form required by the database to be accessed. Database system 101 generates responses to those requests (e.g., copies of selective information, results of queries, acknowledgments of changes made to the information, etc.), which are transmitted to middle tier system 102, and used by middle tier system 102 to provide response to the clients. Middle tier system 102, which handles all direct interaction with clients 103, appears to the clients as the server. From the perspective of database system 101, middle tier system 102 functions as a representative of multiple clients to transmit and receive information from the clients.

Database server system 101 is coupled to middle tier system 102 by a communication path represented as network 104, and middle tier system is in turn coupled to clients 103 by a communication path represented as network 105. Networks 104, 105 could be any form of data communication paths, including broadcast media, direct links between database system 101, middle tier system 102, or one or more clients 103, or indirect links of arbitrary complexity through one or more other systems, routers, or other entities. Networks 104, 105 may be the same network (e.g., the Internet). In a typical environment, network 104 might be a local area network, while network 105 is a broader network, such as the Internet.

FIG. 1 is intended to represent a typical environment at a high level of generality, and is not intended to represent all components of an environment in detail, or all possible permutations of a three-tier or other client-server environment for accessing a database. Numerous variations of the environmental representation of FIG. 1 are possible, of which the following in particular are possible, the description of particular variations herein being intended by way of example only and not by way of limitation. Although database system 101 is shown as a single monolithic entity, it in fact may comprise multiple computer systems upon which data is stored and/or operations performed in a distributed fashion. There may in fact be multiple databases having different organization and interfaces, all accessed by a single middle tier system. Although database system 101, middle tier system 102 and clients 103 are shown as separate and distinct entities coupled by networks, some or all of these may in fact be combined in a single computer system. E.g., database system 101 and middle tier system 102 may be one and the same physical computer system which executes the two software processes of a database manager and the components of a middle tier facility, in which case there would be no physical network 104, communication between the two software processes being handled according to an appropriate inter-process communication protocol within the single computer system. Clients 103 and middle tier 102 could similarly be processes executing on the same computer system, and functions described herein as performed by the middle tier could alternatively be performed by the client directly. Although three clients 103 are represented as single-user workstations, a client could be any entity which might generate service requests requiring access to the database, and could include processes executing on large, multi-user systems; furthermore, the number of clients may vary, and is typically significantly larger than the three clients represented for illustrative purposes in FIG. 1.

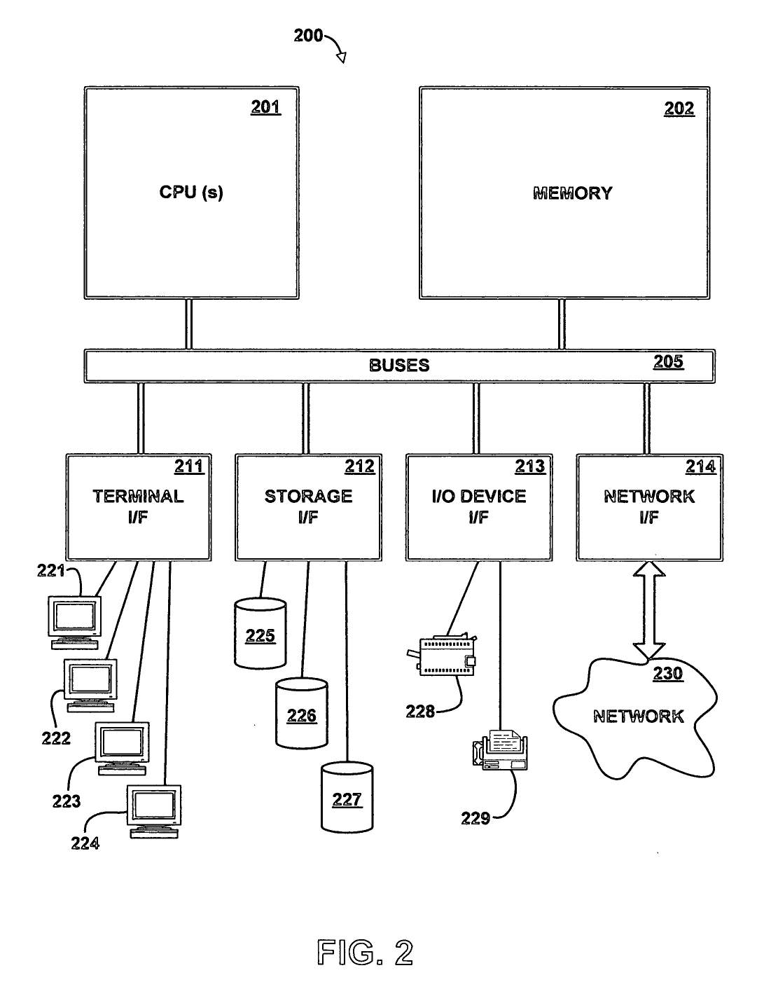

FIG. 2 is a high-level block diagram of the major hardware components of a server computer system 200 for performing services relating to database access on behalf of clients, according to the preferred embodiment. System 200 could represent the hardware components of database system 101, or could represent the hardware components of middle tier system 102, or could represent the hardware components of a single system which performs both the functions of database system 101 and middle tier system 102, as explained above. CPU 201 is at least one general-purpose programmable processor which executes instructions and processes data from main memory 202. Main memory 202 is preferably a random access memory using any of various memory technologies, in which data is loaded from storage or otherwise for processing by CPU 201.

One or more communications buses 205 provide a data communication path for transferring data among CPU 201, main memory 202 and various I/O interface units 211-214, which may also be known as I/O processors (IOPs) or I/O adapters (IOAs). The I/O interface units support communication with a variety of storage and I/O devices. For example, terminal interface unit 211 supports the attachment of one or more user terminals 221-224. Storage interface unit 212 supports the attachment of one or more direct access storage devices (DASD) 225-227 (which are typically rotating magnetic disk drive storage devices, although they could alternatively be other devices, including arrays of disk drives configured to appear as a single large storage device to a host). I/O device interface unit 213 supports the attachment of any of various other types of I/O devices, such as printer 228 and fax machine 229, it being understood that other or additional types of I/O devices could be used. Network interface 214 supports a connection to one or more external networks 230 for communication with one or more other digital devices. Network 230 may represent either network 104 or network 105 or both, and could be embodied as any of various local or wide area networks known in the art. For example, network 230 may be an Ethernet local area network, or it may be the Internet. Additionally, network interface 214 might support connection to additional networks.

It should be understood that FIG. 2 is intended to depict the representative major components of system 200 at a high level, that individual components may have greater complexity than represented in FIG. 2, that components other than or in addition to those shown in FIG. 2 may be present, and that the number, type and configuration of such components may vary, and that a large computer system will typically have more components than represented in FIG. 2. Several particular examples of such additional complexity or additional variations are disclosed herein, it being understood that these are by way of example only and are not necessarily the only such variations.

Although only a single CPU 201 is shown for illustrative purposes in FIG. 2, computer system 200 may contain multiple CPUs, as is known in the art. Although main memory 202 is shown in FIG. 2 as a single monolithic entity, memory 202 may in fact be distributed and/or hierarchical, as is known in the art. E.g., memory may exist in multiple levels of caches, and these caches may be further divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although communications buses 205 are shown in FIG. 2 as a single entity, in fact communications among various system components is typically accomplished through a complex hierarchy of buses, interfaces, and so forth, in which higher-speed paths are used for communications between CPU 201 and memory 202, and lower speed paths are used for communications with I/O interface units 211-214. Buses 205 may be arranged in any of various forms, such as point-to-point links in hierarchical, star or web configurations, multiple hierarchical buses, parallel and redundant paths, etc. For example, as is known in I/O a NUMA architecture, communications paths are arranged on a nodal basis. Buses may use, e.g., an industry standard PCI bus, or any other appropriate bus technology. While multiple I/O interface units are shown which separate system buses 205 from various communications paths running to the various I/O devices, it would alternatively be possible to connect some or all of the I/O devices directly to one or more system buses.

Computer system 200 depicted in FIG. 2 has multiple attached terminals 221-224, such as might be typical of a multi-user “mainframe” computer system. Typically, in such a case the actual number of attached devices is greater than those shown in FIG. 2, although the present invention is not limited to systems of any particular size. User workstations or terminals which access computer system 200 might also be attached to and communicate with system 200 over network 230. Computer system 200 may alternatively be a system containing no attached terminals or only a single operators console containing only a single user display and keyboard input. Furthermore, while certain functions of the invention herein are described for illustrative purposes as embodied in a single computer system, these functions could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 200 is a computer system based on the IBM AS/400™ or i/Series™ architecture, it being understood that the present invention could be implemented on other computer systems.

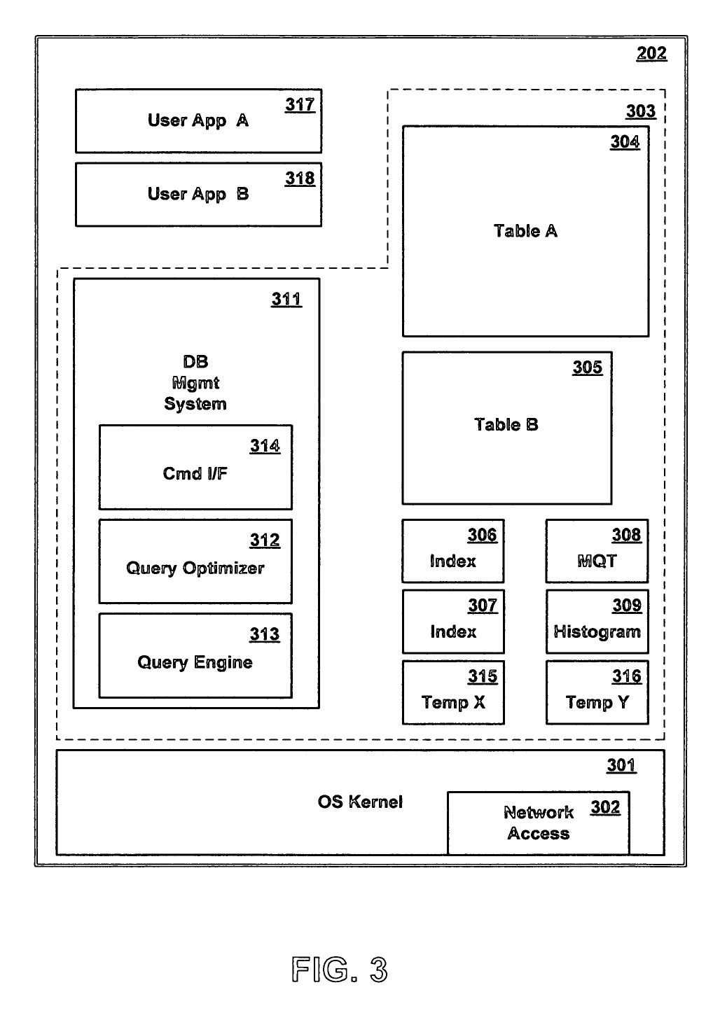

FIG. 3 is a conceptual illustration of the major software components of database system 101, represented as components of memory 202, according to the preferred embodiment. Operating system kernel 301 is executable code and state data providing various low-level software functions, such as device interfaces, management of memory pages, management and dispatching of multiple tasks, etc. as is well-known in the art. In particular, operating system 301 includes at least one network access function 302. Network access function 302 is software which communicates through network interface 214 with one or more external networks, particularly network 104. Network access function 302 generally handles network communications on behalf of applications executing in database server system 101, which specifically includes database management system 311. Although network access function 302 is shown as part of operating system kernel 301, it could alternatively be a separate software module.

A structured database 303 contains data which is maintained by database system 101 and for which the system provides access to multiple users (clients). Database 303 contains one or more tables 304, 305 (of which two are shown in FIG. 3), each having a plurality of entries or records, each entry containing at least one (and usually many) fields, as is well known in the art. Database tables 304, 305 might contain almost any type of data which is provided to users by a computer system. Associated with the database tables are one or more auxiliary data structures 306-309, also sometimes referred to as metadata. Auxiliary data structures characterize the structure of the database and data therein, and are useful in various tasks involved in database management, particularly in executing queries against the database. Examples of auxiliary data structures include database indexes 306-307, materialized query table 308, and histogram 309, it being understood that other types of metadata may exist.

Database management system 311 provides basic functions for the management of database 303. Database management system 311 may theoretically support an arbitrary number of database tables, which may or may not have related information, although only two tables are shown in FIG. 3. Database management system 311 preferably allows users to perform basic database operations, such as defining a database, altering the definition of the database, creating, editing and removing records in the database, viewing records in the database, defining database indexes, and so forth. Among the functions supported by database management system 311 is the making of queries against data in database tables 304,305. Query support functions in database management system 311 include query optimizer 312 and query engine 313. Optimizer 312 generates query execution strategies for performing database queries according to any of various techniques now known or hereafter developed, i.e. sequences of steps in which records will be examined for satisfaction of the query conditions. Engine 313 executes the queries according to strategies developed by optimizer 312.

Database management system 311 further contains command interpreter/interface 314 for receiving external commands in a pre-defined format and executing these commands. Commands might include, e.g., queries to be run against data in the database, data updates, creation and deletion of database records, and so forth. These commands may include conditional commands which execute upon the successful evaluation of some stated condition, and/or branch commands, so that a series of commands may have arbitrary complexity and take the form of an interpreted computer program which is executed by database management system functioning as an interpreter. In the preferred embodiment, commands interpreted by command interface 314 include one or more commands for altering a resource allocation to a client or set of clients, as explained in greater detail herein.

Database management system 311 may further contain any of various more advanced database functions. Although database management system 311 is represented in FIG. 3 as an entity separate from operating system kernel 301, it will be understood that in some computer architectures various database management functions are integrated with the operating system.

In addition to internal state information and other data, database management system 311 may generate numerous temporary data structures during execution, represented as data structures 315-316. These temporary structures in particular are often generated during query execution to hold intermediate query results. The number of such temporary structures can vary considerably, and could be much larger.

Although one database 303 having two database tables 304, 305, two indexes 306-307, one MQT 308 and one histogram 309 are shown in FIG. 3, the number of such entities may vary, and could be much larger. The computer system may contain multiple databases, each database may contain multiple tables, and each database may have associated with it multiple indexes, MQTs, histograms, or other auxiliary data structures not illustrated. Alternatively, some entities represented in FIG. 3 might not be present in all databases; for example, some databases might not contain materialized query tables or the like. Additionally, database 303 may be logically part of a larger distributed database which is stored on multiple computer systems. Although database management system 311 is represented in FIG. 3 as part of database 303, the database management system, being executable code, is sometimes considered an entity separate from the “database”, i.e., the data.

In the preferred embodiment, at least some of the clients using the database access the database through middle tier system 102, which generates requests for service to, and receives responses from, database management system 311. However, database system 101 may optionally include additional user applications 317, 318, which directly use command interface 314 or some other mechanism to call database management system 311 to access information in database 302, without passing requests through middle tier system 102. Alternatively, while a user application will typically invoke database management system to access data in the database, a user application could access the database tables directly using its own built-in access routines.

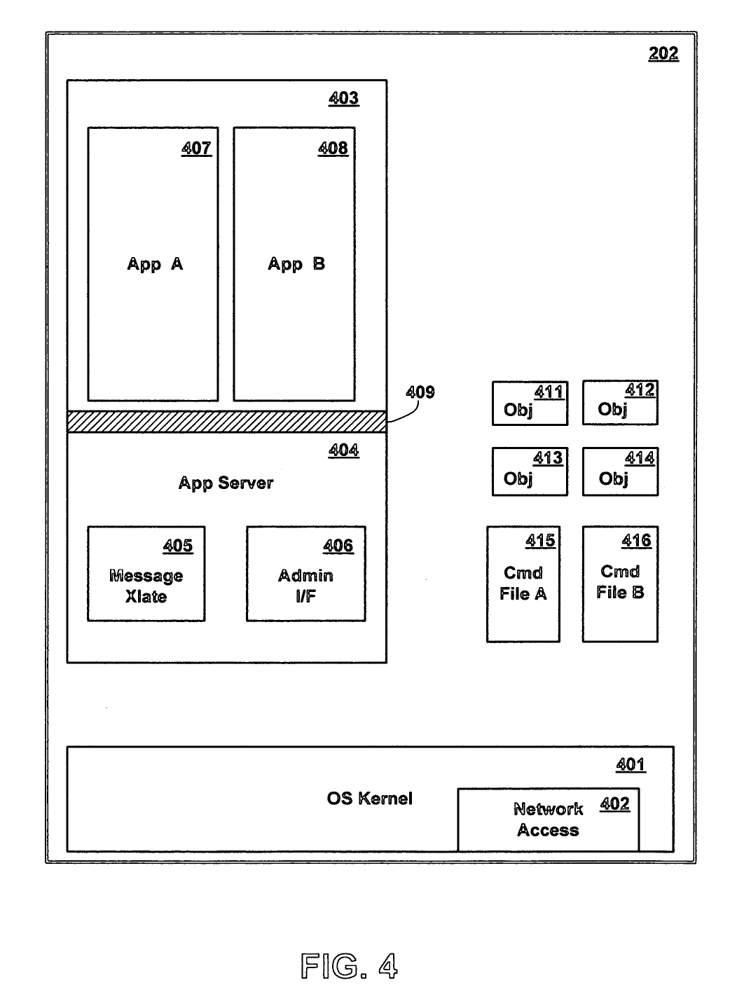

FIG. 4 is a conceptual illustration of the major software components of middle tier system 102, represented as components of memory 202, according to the preferred embodiment. Operating system kernel 401 and network access function 402 provide function analogous to those of operating system kernel 301 and network access function 302, respectively, of database system 101. While the functions provided are analogous, operating systems 301 and 401 are not necessarily identical (although they could be). Network access function 402 communicates through network interface 214 to networks 104, 105, which could be separate networks operating under different protocols, separate networks operating under the same protocol, or the same network. In the preferred embodiment, network 105 is the Internet.

A middle tier server facility 403 acts as client representative to access one or more databases, and in particular to access database 303. In the preferred embodiment, middle tier facility 403 presents an interactive world wide web interface to multiple clients 103 which communicate with middle tier system 102 over the Internet. I.e., middle tier facility 403 generates interactive web pages in HTML or other appropriate format for viewing by web browser applications executing in client systems 103. To clients 103, middle tier facility 403 functions as the server, and clients are unaware of any applications behind middle tier facility 403. However, in some transactions the middle tier in reality functions as an intermediary. It translates data received from clients 103 (such as request for access to database 303) from HTML or other web-based form to a form compatible for use by database management system 311, i.e., to a command format compatible with command interface 314. It further receives responses to its requests from database management system 311 in the native format of the database, and converts the information in these responses to some form appropriate for the client, such as a web-based format.

In the preferred embodiment, middle tier facility 403 comprises an application server 404, and one or more middle tier applications 407,408 (of which two are illustrated in FIG. 4, it being understood that the number could vary). Application server 404 is a framework or shell for generally supporting database accesses on behalf of the applications 407,408 of the middle tier. Among other features, application server 404 contains a set of functions (connection facilities) for accessing databases in a variety of commonly used native database formats. The applications 407, 408 are code developed for performing some set of specific server functions on behalf of clients 103, at least some of which require access to the database. The applications 407, 408 receive client requests and make a determination to access data in a database as required. If database access is required by an application 407, 408, it invokes the connection facilities of application server 404 to access the database. Application server 404 receives responses from the database, which are generally forwarded to the appropriate application. Applications 407, 408 communicate with application server 404 across a common interface 409, which is independent of the application or database to be accessed. In the preferred embodiment, interface 409 conforms to a JAVA 2 Enterprise Edition (J2EE) interface specification, although other interfaces might alternatively be used. In the preferred embodiment, application server 404 is a modified version of the IBM WEBSPHERE™ application server, it being understood that other forms of application server facility could alternatively be used.

Application server 404 includes at least one message translation table 405 assigned to database management system 311. The function of message translation table 405 is to support translation of messages received from database manager 311, which is a specific instance of the general function of hiding certain implementation details of the database 303 from clients 103. I.e., various forms of database management software exist, there possibly being multiple versions of each such form, and possible permutations of database organization are virtually infinite. Each form and version may have its own set of messages which are generated to users. Typically, these are coded as integers or similar coded forms, and the coding used by one form of database management software will not match the coding used by others. To most clients, these codes are obscure and difficult to understand. As is known in the art, a message translation table may be provided, whereby coded messages received from a database are translated to some form more readily understandable by the clients, such as a corresponding textual explanation. The table preferably contains references to objects containing the textual explanation 411-414, of which four are represented in FIG. 4, it being understood that the number could vary, and is typically larger. Textual explanations could alternatively be embedded in the table itself. If application server 404 accesses multiple different databases having different respective database management systems, it can not be assumed that messages from the different databases employ the same encoding, and therefore a separate message translation table is provided for each such database.

In accordance with the preferred embodiment, a message translation table 405 for correlating coded error messages to text is modified to include at least some references to sets of database commands. A reference to a set of database commands may be implemented in either of two ways. In a first embodiment, sets of commands are contained in respective command files 415, 416, of which two are represented in FIG. 4, it being understood that the number could vary, and is typically larger. In this embodiment, the command file is transmitted to the database for execution. In a second embodiment, the table values are themselves commands, typically a single respective command corresponding to each of various messages. In the second aspect, the commands are issued directly to the database via a JAVA database connection (JDBC). A set of database commands comprises one or more commands according to the database command interface protocol implemented by command interface 314 in database management system 311. These commands specify actions to be taken (as opposed to textual messages) in response to receipt of certain messages, as more fully explained herein. Preferably, command interface 314 supports branching and conditional commands, and a sequence of commands may therefore be viewed as a computer program. Although this “program” is not directly executable (it is “executed” by passing it to database command interface 314, which acts as a command interpreter), but it may have arbitrary complexity. In particular, in accordance with the preferred embodiment, at least one of the commands available in the command line interface will increase one or more resources allocated to a user (or entity representing multiple end users, such as middle tier system 102) of the database.

Application server 404 further includes an administrator interface 406 for the application server. This is preferably an interactive screen interface by which the administrator may specify various configuration parameters. The administrator interface supports configuration of the application server by an application server administrator. For example, the application server administrator can define a list of authorized clients, connection information, authority of each client to access particular services, etc. The administrator may also configure one or more database interfaces, i.e., define the locations of the databases, method of access, request protocols, and so forth. In particular, in the preferred embodiment, the administrator may configure message translation table 405. by associating coded messages with text or command sequences.

Various software entities are represented in FIG. 3 and/or 4 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representations of FIGS. 3 and 4, it will be understood that the actual number of such entities may vary, and in particular, that in a complex database server environment, the number and complexity of such entities is typically much larger. Additionally, although the various software components are depicted in FIGS. 3 and 4 on two computer systems, these entities might alternatively be contained on a single computer system, or might be distributed among a number of systems larger than two. For example, user applications may be on a separate system from the database; database table data may be distributed among multiple computer systems, so that queries against the database are transmitted to remote systems for resolution, and so forth.

While the software components of FIGS. 3 and 4 are shown conceptually as residing in memory 202, it will be understood that in general the memory of a computer system will be too small to hold all programs and data simultaneously, and that information is typically stored in data storage devices 125-127, comprising one or more mass storage devices such as rotating magnetic disk drives, and that the information is paged into memory by the operating system as required. In particular, database 303 is typically much too large to be loaded into memory, and typically only a small portion of the total number of database records is loaded into memory at any one time. The full database 303 is typically recorded in disk storage 125-127. Furthermore, it will be understood that the conceptual representation of FIGS. 3 and 4 is not meant to imply any particular memory organizational model, and that system 101 or system 102 might employ a single address space virtual memory, or might employ multiple virtual address spaces which overlap.

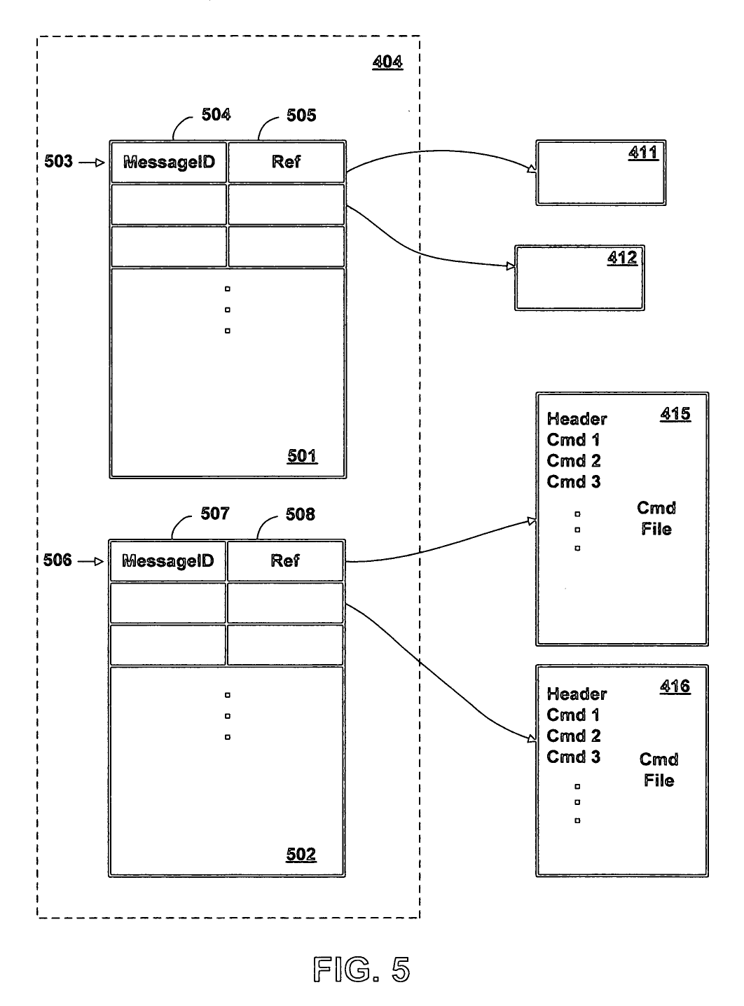

FIG. 5 is a conceptual representation of the structure of message translation table 405 and entities it references, according to the preferred embodiment. Message table 405 is divided into two sections 501, 502, comprising a text translation section 501 and an action translation section 502. Each section contains a respective plurality of entries 503, 506.

Each entry 503 in text translation section 501 contains a respective message identifier field 504 and reference field 505. Message identifier field 504 identifies a message according to a message encoding used by database 303. For example, database 303 may issue messages encoded as integers (“error number”), and the message identifier field may contain the integer identifying a type of message. However, other forms of encoding could alternatively be used. Reference field 505 contains a reference to the corresponding text translation of the encoded message type which is to be transmitted to the client. In the preferred embodiment, reference field 505 contains a pointer to a JAVA text object in which the corresponding text is contained along with other data relating to the message, as illustrated by pointers to JAVA text objects 411, 412. However, the text translation could be stored in forms other than a JAVA text object and referenced in other ways in table 405. For example, reference field 506 could be an index to a table of textual translations, or could contain the actual text itself.

Each entry 506 in action translation section 502 similarly contains a respective message identifier field 507 and reference field 508. Message identifier field 507 identifies a message according to the message encoding used by database 303, similarly to message identifier field 504. Reference field 508 contains a reference to an action to be taken in response to the message of corresponding type. In the preferred embodiment, reference field 508 is either a file identifier of a file of database commands, as illustrated by arrows to database command files 415, 416, or a set of one or more database commands, it being understood that an action could be specified in some other manner.

Text translation section 501 and action translation section 502 are illustrated in FIG. 5 as separate entities within message translation table 405, and are so implemented in the preferred embodiment. However, it would alternatively be possible to combine these sections as a single table. Although message translation table 405 and its component sections are illustrated and described as “tables”, this description is conceptual and does not necessarily imply any particular data structure. Any of various data structures as are known in the art could be used, and various additional fields such as pointers, indexes and so forth (not shown) may be present.

In accordance with the preferred embodiment, middle tier system 102 functions as a representative of clients 103 to database system 101, and in particular handles error messages received from database system 101 in response to client requests. The application server 404 within the middle tier handles error messages by referring to message translation table 405, which supports either a text translation of a message or a responsive action. For at least one error message which amounts to denial of service for lack of database resources allocated to clients represented by the application server, the application server automatically performs a responsive action causing the database to allocate more resources. Specifically, application server references message translation table 405 to obtain a command file 415 corresponding to the encoded error message identifier, and transmits a series of commands to the database contained in the command file. At least one such command file contains commands to the database which cause the database to allocate more resources, allowing the request to be satisfied. The middle tier application (407 or 408) preferably will automatically retry the request once additional resource is available. Preferably, this allocation of additional resource and retrying of the request is done automatically by the application server and middle tier application, respectively without involvement of the client, and to the client the handling of the original request appears seamless.

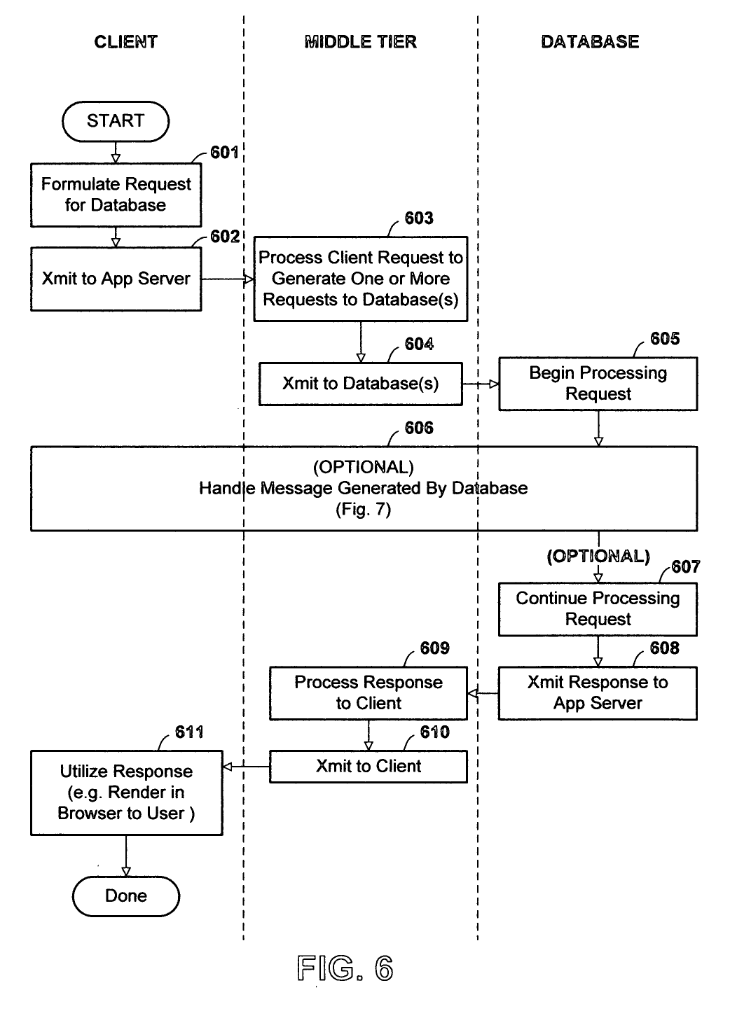

FIG. 6 is a flow diagram illustrating at a high level the process of servicing a client request for database access through the middle tier, according to the preferred embodiment. Referring to FIG. 6, the flow diagram is divided into three partitions running vertically, these indicating the actions performed at each of the client, the middle tier, and the database. A client formulates a request for service which requires access to information contained in one or more databases in a form convenient to the client (step 601). In the preferred embodiment, the client executes an interactive web browser process, and the request is formulated by interactively entering appropriate information in entry fields of a web page provided by the middle tier. However, formulation of the request at the client could be accomplished by different means, need not be interactive, and need not use web-based protocols. The request formulated by the client is then transmitted to the middle tier (step 602).

On receipt of the request from the client, the middle tier processes the request, causing it to generate one or more access requests to a database (step 603). A single client request may cause the middle tier to generate multiple database requests, which may be directed to a single database or to multiple different databases. Typically, the client only requests data in a general sense without reference to specific databases, and the middle tier application determines the location (or multiple locations) of the data to be accessed. The application invokes the application server to access the necessary database(s), and the application server then formulates one or more access requests according to the native format(s) of the accessed database(s). The application server then transmits the request(s) to the database(s) (step 604).

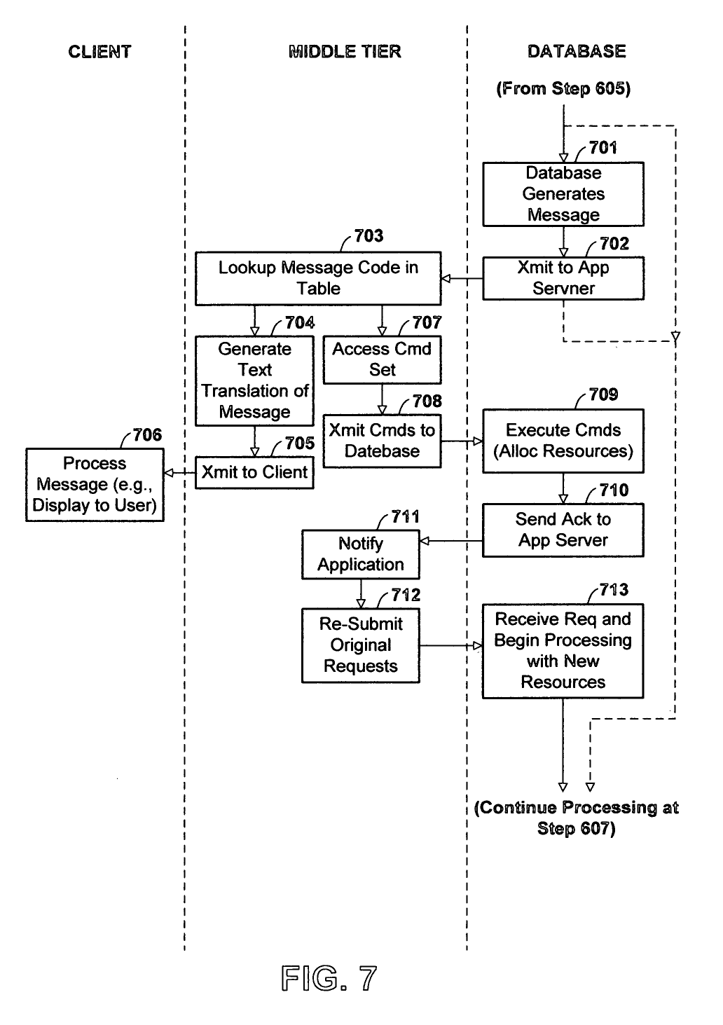

On receipt of the request from the application server, the database begins processing the request (step 605). At some point during processing, the database may optionally generate a message for the client, which is transmitted to application server for handling. This step is shown generally in FIG. 6 as step 606, and is shown in greater detail in FIG. 7, described below. For some messages, the generation and transmission of the message completes the transaction, without further processing of the request. If further processing of the transaction is required, or if no message was generated, further processing is indicated by step 607, followed by transmission of the completed response to the application server (step 608).

The application server receives the response from the database, which is passed on to the middle tier application. The application performs any additional processing to produce a response in a form appropriate for the client (step 609). In some cases, the application may receive multiple responses from multiple respective databases, and combine the responses for presentation to the client. In the preferred embodiment, the responses are formatted for presentation in an interactive web browser of the client according to any appropriate formatting standard, such as HTML. However, the client need not be a web browser, and responses could be formatted in any of various other forms. The translated response is then transmitted to the client (step 610). Upon receipt, the client uses the response in accordance with its intention (step 611). In the preferred embodiment, a web browser in the client renders the response into a user viewable web page displaying the requested data, acknowledging a transaction, or providing some other information.

FIG. 7 shows in greater detail the process of generating and handling a message from the database, according to the preferred embodiment, represented in FIG. 6 as step 606. Referring to FIG. 7, because a message is not always generated responsive to a database access request, a flow path by-passing the message handling steps 701-713 might be taken in some circumstances, as indicated by the dashed by-pass line.

The database system 101 (specifically, a process in database manager 311 executing in system 101) generates a message while servicing a request received from the application server (step 701). This message is then transmitted back to the application server. Depending on the character of the message, the database may either halt processing of the transaction, or continue processing the transaction without waiting for a response (represented by the dashed line path from step 702).

On receipt of a message from the database, application server 404 accesses message translation table 405 to determine the appropriate action (step 703). I.e., at least some data in the message, such as a message type identifier, is used to access a corresponding entry in table 405, which might be in the text translation section 501 or the action translation section 502. The table could be accessed using any of various table look-up techniques known in the art, such as hashing, and different sections of table 405 could have a hierarchically defined search order, such that one section is first examined for a corresponding entry, and if not found, a next section is examined.

If an entry 503 in text translation section 501 is found, the reference field 505 of the entry is used to access a corresponding data structure (preferably a JAVA object) containing the message text to be provided to the application. The application may use this text to generate a message for the client (step 704), and/or may perform some other action, such as log the message. Where appropriate, the message is then transmitted to the client (step 705), and the client processes the message appropriately e.g., displays the message to a user. (step 706).

If an entry 506 in actions translation section 502 is found, the reference field 508 of the entry is used to access a corresponding set of commands in a command file 415, 416 or other set of commands to be executed (step 707). In the preferred embodiment, these commands are commands according to a command line interface to database manager 311 which are processed by command line interface 314. An example of such a command line interface is a DB2 command line interface or the SQLPWS command line interface in ORACLE™, it being understood that other command line interfaces could be used. Application server 404 transmits either a command file 415, 416 containing commands, or a set of commands themselves, to database system 104 for execution by command interface 314 of database manager 311 (step 708).

In the preferred embodiment, one or more sets of commands transmitted in response to messages include commands which, when executed by command interface 314, cause database manager 311 to allocate more resources to clients represented by the middle tier. Resources allocated by the database may include, among other things: a maximum number of users concurrently supported (i.e., a maximum number of clients which can be represented by middle tier 102 at any given time); a maximum number and/or size of temporary data structures 315, 316 allocated for supporting database queries or other operations on behalf of clients represented by middle tier 102; a maximum size and/or number of logs allocated for logging database activity on behalf of clients represented by applications server 102; etc. However, it should be understood that these resources are listed by way of example and not limitation, and other or additional resources may be allocated. A set of commands for allocating resources may include conditional commands which allocate certain resources only if some condition or conditions are met. For example, the set of commands may condition the allocation of additional resources on the current state of the database system or amount of resource currently allocated to all users, in order to avoid overloading the system. As one specific example, the allocation of additional memory structures might be conditioned on the amount of memory already allocated to other processes

The database manager's command interface 314 receives the commands from the application server and causes them to be executed by calling appropriate database manager functions for executing each respective command (step 709). In the case of a set of commands for allocating resources, execution of the command may have the effect of allocating the additional database resource to clients represented by the middle tier, or may have the effect of allocating additional resources to a middle tier application, or may have the effect of allocating additional resources to the database itself for general use by all clients. When the commands have been executed, an appropriate acknowledgment of completion is sent to the application server (step 710).

On receipt of the acknowledgment, the application server takes appropriate action. Specifically, in the case of a command file which allocates additional resources, application server responds to the acknowledgment by notifying the middle tier application which submitted the original request (step 711). The appropriate action taken by the middle tier application is in the hands of the application, and may vary according to the intention of the application's designers, preferably the middle tier application automatically re-submits the original request to the database (step 712). The database receives the re-submitted request and begins processing (step 712). In this case, because additional resource has been allocated, the database should be able to process the request normally and provide requested service for the client.

Among the advantages of the technique described herein as a preferred embodiment is the relatively low overhead of implementation, and the flexibility to deal with a variety of conditions and environments. By using an extension of an error message table in an application server and an existing command line interface, a conventional application server can be readily modified to address the problem of lack of allocated database resources, irrespective of the existence of automatic resource allocation in the database itself. Furthermore, once the basic mechanism is in place as described herein, additional command files or other sets of commands for allocating resources or responding to other message conditions can be readily created, and existing sets of commands can easily be edited to accommodate changing conditions.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, recordable type media such as volatile and non-volatile memory devices, floppy disks, hard-disk drives, CD-ROM's, DVD's, magnetic tape, and transmission-type media such as communications networks. Examples of signal-bearing media are illustrated in FIG. 2 as system memory 202, and as data storage devices 225-227.

Although a specific embodiment of the invention has been disclosed along with certain alternatives, it will be recognized by those skilled in the art that additional variations in form and detail may be made within the scope of the following claims:

What is claimed is:

1. A method for accessing a database, comprising the computer-executed steps of:
submitting a request for a database access operation to said database;
responsive to requesting said database access operation, receiving a lack of resource message from said database, said lack of resource message indicating lack of sufficient allocated resources of at least one type to process said request;
responsive to receiving said lack of resource message, automatically submitting to said database a set of one or more commands executable by at least one database computer system, wherein said set of commands, when executed by said at least one database computer system, cause additional resources of at least one type to be allocated; and
automatically re-trying said database access operation after said set of commands has executed.

2. The method for accessing a database of claim 1, wherein said method is performed in a middle tier for accessing said database on behalf of a plurality of clients.

3. The method for accessing a database of claim 2, wherein said middle tier communicates with said plurality of clients over the Internet and provides an interactive web interface for accessing said database.

4. The method for accessing a database of claim 2, wherein said middle tier comprises an application server and at least one middle tier application, said application server communicating with said database using an interface defined by said database, and providing a common database-independent interface for communication with said at least one middle tier application.

5. The method for accessing a database of claim 1, wherein said method is performed in a requesting computer system, said requesting computer system being other than said at least one database computer system, said requesting computer system communicating with said at least one database computer system across a network.

6. The method for accessing a database of claim 1, wherein the commands of said set of commands are commands according to a command line interface executable by said database.

7. The method for accessing a database of claim 1, wherein said step of automatically submitting to said database a set of commands executable by said at least one database computer system comprises the steps of:
accessing an entry in a message table corresponding to said lack of resource message, said entry in said message table containing a reference to said set of commands; and
accessing said set of commands using said reference.

8. The method for accessing a database of claim 7, wherein said message table comprises a plurality of entries, each entry corresponding to a respective message type and defining an action to be taken upon receipt of a message of the corresponding type, wherein at least some of said entries specify textual data to be provided to a user, and wherein at least some of said entries specify sets of commands to be submitted to said database for execution.

9. A computer program product for accessing a database, comprising:
a plurality of computer executable instructions recorded on signal-bearing media, wherein said instructions, when executed by at least one computer system, cause the at least one computer system to perform the steps of:
submitting a request for a database access operation to said database;
responsive to requesting said database access operation, receiving a lack of resource message from said database, said lack of resource message indicating lack of sufficient allocated resources of at least one type to process said request;
responsive to receiving said lack of resource message, automatically submitting to said database a set of one or more commands executable by at least one database computer system, wherein said set of commands, when executed by said at least one database computer system, cause additional resources of at least one type to be allocated; and
automatically re-trying said database access operation after said set of commands has executed.

10. The computer program product for accessing a database of claim 9, wherein said method is performed in a middle tier for accessing said database on behalf of a plurality of clients.

11. The computer program product for accessing a database of claim 10, wherein said middle tier communicates with said plurality of clients over the Internet and provides an interactive web interface for accessing said database.

12. The computer program product for accessing a database of claim 10, wherein said middle tier comprises an application server and at least one middle tier application, said application server communicating with said database using an interface defined by said database, and providing a common database-independent interface for communication with said at least one middle tier application.

13. The computer program product for accessing a database of claim 9, wherein said program product executes in a requesting computer system, said requesting computer system being other than said at least one database computer system, said requesting computer system communicating with said at least one database computer system across a network.

14. The computer program product for accessing a database of claim 9, wherein the commands of said set of commands are commands according to a command line interface executable by said database.

15. The computer program product for accessing a database of claim 9, wherein said step of automatically submitting to said database a set of commands executable by said at least one database computer system comprises the steps of:
accessing an entry in a message table corresponding to said lack of resource message, said entry in said message table containing a reference to said set of commands; and
accessing said set of commands using said reference.

16. The computer program product for accessing a database of claim 15, wherein said message table comprises a plurality of entries, each entry corresponding to a respective message type and defining an action to be taken upon receipt of a message of the corresponding type, wherein at least some of said entries specify textual data to be provided to a user, and wherein at least some of said entries specify sets of commands to be submitted to said database for execution.

17. A middle tier system for accessing a database on at least one database computer system on behalf of a plurality of clients, comprising:
at least one processor;
a memory for storing data including instructions executable on said at least one processor;
a middle tier facility embodied as instructions storable in said memory and executable on said at least one processor, said middle tier facility responding to requests for service from a plurality of clients, at least some of said requests requiring access to said database, said middle tier facility generating requests to access said database responsive to at least some of said requests for service;
wherein, responsive to receiving a lack of resource message from said database, said lack of resource message indicating lack of sufficient allocated resources to process an access request to access said database, said middle tier facility automatically submits a set of one or more commands to said database, wherein said commands, when executed by said at least one database computer system, cause additional resources to be allocated for servicing said access request; and
wherein said middle tier facility automatically re-tries said access request after said set of commands has executed.

18. The middle tier system of claim 17, wherein said middle tier facility comprises an application server and at least one middle tier application, said application server communicating with said database using an interface defined by said database, and providing a common database-independent interface for communication with said at least one middle tier application.

19. The middle tier system of claim 17, wherein said middle tier system and said at least one database system are separate computer systems, said middle tier system communicating with said at least one database computer system across a network.

20. The middle tier system of claim 17, wherein the commands of said set of commands are commands according to a command line interface executable by said database.
